(19) United States
(12) Patent Application Publication
(10) Pub. No.: US 2004/0159722 A1
(43) Pub. Date: Aug. 19, 2004

(54) Fuel injection valve

(76) Inventors: Ferdinand Reiter, Markgroeningen (DE); Martin Maier, Moeglingen (DE)

Correspondence Address: KENYON & KENYON, ONE BROADWAY, NEW YORK, NY, 10004, US

(21) Appl. No.: 10/473,501

(22) PCT Filed: Nov. 29, 2002
(86) PCT No.: PCT/DE02/04386

(30) Foreign Application Priority Data
Jan. 30, 2002 (DE) 102 03 659.4

(51) Int. Cl. B05B 1/30

(52) U.S. Cl. 239/584

(57) ABSTRACT

A fuel injector for the direct injection of fuel into the combustion chamber of a mixture-compressing internal combustion engine having external ignition includes a piezoelectric or magnetostrictive actuator and a valve needle, which, via a compensation element, is in operative connection to the actuator, a valve-closure member being formed on the valve needle, which cooperates with a valve-seat surface to form a sealing seat. The compensation element is filled with a rheological liquid.

### BACKGROUND INFORMATION

The present invention is directed to a fuel injector of the type set forth in the main claim.

Known from the published European Patent 0 477 400 A1 is a path transformer for a piezoelectric actuator in which the actuator transmits a lifting force to a master cylinder sealed by a cylinder support. Guided in this master cylinder is a slave piston, which likewise seals the master cylinder and thereby forms the hydraulic chamber. Arranged in the hydraulic chamber is a spring that presses the master cylinder and the slave piston apart. The slave piston mechanically transmits a lifting movement to a valve needle, for instance. When the actuator transmits a lifting movement to the master cylinder, this lifting movement is transmitted to the slave piston by the pressure of an hydraulic fluid in the hydraulic chamber, since the hydraulic fluid in the hydraulic chamber is not compressible and only a very small portion of the hydraulic fluid is able to escape through the ring gap during the short duration of a lift. In the rest phase, when the actuator does not exert any compressive force on the master cylinder, the spring pushes the slave piston out of the cylinder and, due to the generated vacuum pressure, the hydraulic fluid penetrates and replenishes the hydraulic chamber via the ring gap. In this way, the path transformer automatically adapts to linear deformations and pressure-related expansions of a fuel injector.

Disadvantageous in the coupler arrangement known from the

European Patent 0 477 400 A1 is, in particular, the high expense caused by the high manufacturing precision required for the components. Furthermore, in opening pulses that occur in close succession, the coupler medium escapes from the coupler gap and, due to the narrow width of the leakage gap, is unable to continue flowing fast enough, so that the switching dynamics of fuel injectors with hydraulic couplers is limited.

DE 197 35 232 A1 does disclose the use of an electro-rheological liquid in a fuel injector, the fuel injector being provided with a damping element connected to the valve needle of the fuel injector to model the injection profile or the injected fuel quantity. In response to an excitation or de-excitation of the electromagnet, the damping element effects a flow of an electro-rheological fluid into a damping chamber via a capacitive component. With the aid of the capacitive component, the viscosity of the electro-rheological fluid is able to be modified by an electronic control device as a function of operating parameters of the internal combustion engine, in such a way that the movement profile of the damping element is implemented such that the fuel spray-discharged via the spray-discharge orifice assumes a desired jet form or is spray-discharged at a desired time. The use of the rheological fluid for a compensation element for piezoelectric or magnetostrictive actuators is not described there, however.

### SUMMARY OF THE INVENTION

In contrast, the fuel injector according to the present invention, having the characterizing features of the main claim, has the advantage over the related art that a sealed compensation element, filled with a rheological liquid, is disposed on the downstream side of the piezoelectric or magnetostrictive actuator, which, on the one hand, compensates for the slow thermal expansion of the different components of a fuel injector and, on the other hand, transmits rapid switching movements of the actuator to the valve needle as opening pulses.

Advantageous further developments of the fuel injector specified in the main claim are rendered possible by the measures elucidated in the dependent claims.

In an advantageous manner, the compensation element is formed by a pot and a top, the pot being flexurally stiff and the top having a flexible design.

It is also advantageous that the top is provided with crimps, which improve the elastic deformability of the top.

Furthermore, it is advantageous that the pot of the compensation element is easy to produce by deep-drawing. After filling, the top may be hermetically joined to the pot, so that it is easy to install the filled compensation element in the fuel injector as an overall component.

### BRIEF DESCRIPTION OF THE DRAWINGS

An exemplary embodiment of the present invention is represented in the drawing in simplified form and explained in greater detail in the following description.

The Figures Show:

FIG. 1 a schematic section through an exemplary embodiment of a fuel injector configured according to the present invention; and

FIG. 2 a cut-away portion of the exemplary embodiment represented in FIG. 1 of the fuel injector configured according to the present invention, in area II in FIG. 1.

### DESCRIPTION OF THE EXEMPLARY EMBODIMENT

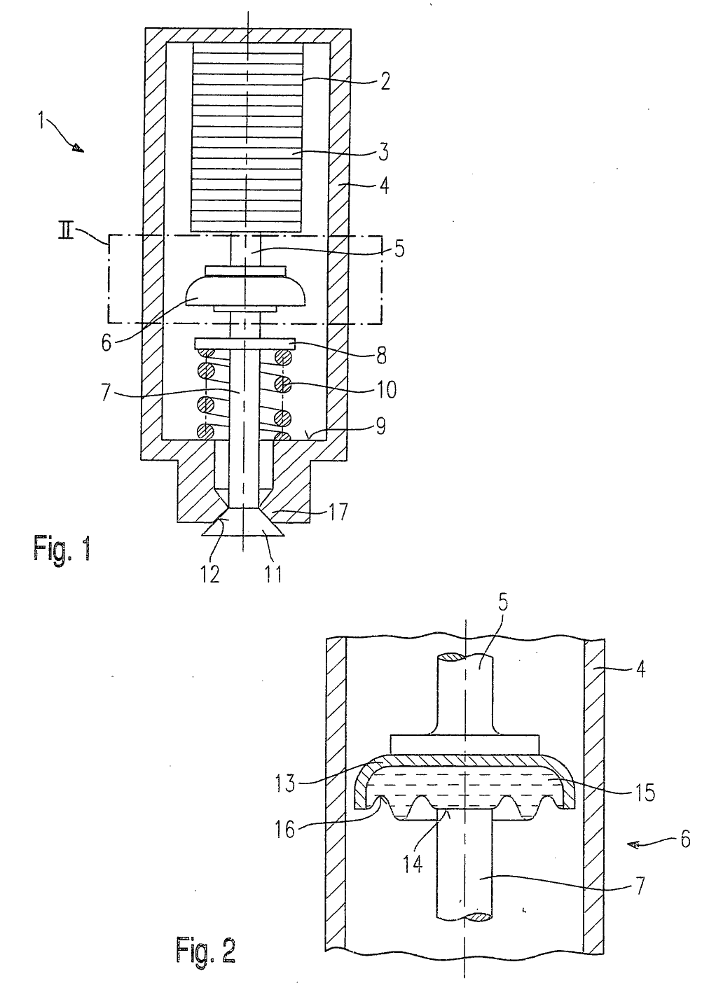

An exemplary embodiment of a fuel injector 1 according to the present invention, shown in FIG. 1, is designed in the form of a fuel injector 1 for fuel-injection systems of mixture-compressing internal combustion engines having externally supplied ignition. Fuel injector 1 is suited, in particular, for the direct injection of fuel into a combustion chamber (not shown) of an internal combustion engine.

Fuel injector 1 includes an actuator 2, which is made up of piezoelectric layers 3, for instance. Actuator 2 is encapsulated in a housing 4 on which actuator 2 is supported at an end face.

On the downstream side of actuator 2 is an actuating element 5, which has the shape of a piston and abuts against a compensation element 6. A detailed description of compensation element 6 and its functioning method may be inferred from the description in connection with FIG. 2.

Downstream from compensation element 6 is a valve needle 7 to which a support disk 8 is connected by force locking. Disposed between support disk 8 and a housing shoulder 9 is a restoring spring 10, which acts on valve needle 7 in such a way that a valve-closure member 11 joined to valve needle 7 is retained in sealing contact at a valve-seat surface 12. In the exemplary embodiment, this valve-seat surface 12 is formed on a valve-seat body 17 integrated in housing 4 of fuel injector 1.

If fuel injector 1 is energized via an electrical line (not shown further), piezoelectric layers 3 of actuator 2 expand, thereby moving actuating element 5, compensation element 6 and valve needle 7 counter to the force of restoring spring 10, in the discharge direction. Valve-closure member 11, which is in operative connection to valve needle 7, lifts off from valve-seat surface 12, thereby injecting fuel into the combustion chamber (not shown further) of the internal combustion engine.

If the energy supply to actuator 2 ceases, piezoelectric layers 3 contract, which causes restoring spring 10 to move valve needle 7, via pressure on support disk 8, counter to the discharge direction. Valve closure member 11 sets down on valve-seat surface 12, thereby closing fuel injector 1.

In an enlarged, schematic view, FIG. 2 shows the cut-away portion designated II in FIG. 1, in the region of compensation element 6.

Compensation element 6 is provided to compensate for slow linear deformations caused by thermal influences, especially of actuator 2, so that valve-closure member 11 does not lift off from valve-seat surface 12 as a result of the slow thermal expansion of actuator 2. In contrast, rapid linear deformations of actuator 2 when power is supplied to switch fuel injector 1, should be transmitted to valve needle 7.

According to the present invention, compensation element 6 is therefore made up of a cup-shaped pot 13, which may be produced by deep-drawing, for example, and a top 14, which seals pot 13 and may be joined thereto by a circumferential welded seam. Braced on pot 13 on the inflow side is piston-shaped actuating element 5, while valve needle 7 abuts against top 14. Pot 13 is filled with a Theological fluid 15 prior to being sealed, before top 14 is mounted and pot 13 hermetically sealed.

The thickness of the material of pot 13 is preferably selected such that pot 13 is flexurally stiff, while the material of top 14 is selected to be thinner and thus to be more flexible. In addition, to further increase the flexibility of top 14, crimps 16 may be provided, which are, for example, implemented on top 14 in an annular shape. Due to the flexibility of top 14, it is possible for it to be elastically deformed in a reversible manner once various components of fuel injector 1 warm up as a result of the thermal loading during operation of the internal combustion engine, and thus undergo linear deformation.

At low loading speed, sealed-in Theological fluid 15 behaves like a liquid, i.e., top 14 is pressed into pot 13 by the mutually opposing forces of expanding actuator 2 and restoring spring 10, so that fuel injector 1 remains closed despite the thermal linear deformation. On the other hand, at high actuation speed, i.e., when actuator 2 is energized to open fuel injector 1, rheological fluid 15 behaves like a solid body so that compensation element 6 reacts in a rigid manner and transmits the lift of actuator 2 to valve needle 7.

Such a system has the advantage, above all, that compensation element 6 is easy and inexpensive to manufacture. Furthermore, compensation element 6 has the advantage over an hydraulic coupler that the functional scope of piezoelectric actuator 2 is not restricted. Whereas, in the case of an hydraulic coupler, the coupler medium between the pistons escapes when two pulses occur in rapid succession and the time is too short for a backflow, compensation element 6 with Theological liquid 15 is able to react to any opening pulses, no matter how quickly they follow one another.

The present invention is not limited to the exemplary embodiment shown and is also suited, for instance, to magnetostrictive actuators 2 and for any other configurations of fuel injectors 1.

What is claimed is:

1. A fuel injector (1) for the direct injection of fuel into the combustion chamber of a mixture-compressing internal combustion engine having external ignition, comprising a piezoelectric or magnetostrictive actuator (2) and a valve needle (7), which is in operative connection to the actuator (2) via a compensation element (6), a valve-closure member (11) being formed on the valve needle (7), which cooperates
with a valve-seat surface (12) to form a sealing seat, wherein the compensation element (6) is filled with a rheological liquid (15).

2. The fuel injector as recited in claim 1,
wherein the compensation element (6) has a pot (13) having a dish-shaped form.

3. The fuel injector as recited in claim 2,
wherein the compensation element (6) has a top (14).

4. The fuel injector as recited in claim 3,
wherein the top (14) is hermetically joined to the pot (13).

5. The fuel injector as recited in one of claims 2 through 4,
wherein the thickness of the material forming the pot (13) is selected such that the pot (13) is flexurally stiff.

6. The fuel injector as recited in one of claims 3 through 4,
wherein the thickness of the material forming the top (14) is selected such that the top (14) is elastically deformable.

7. The fuel injector as recited in claim 6,
wherein the top (14) has crimps (16).

8. The fuel injector as recited in claim 7,
wherein the crimps (16) are formed on the top (14) in an annular manner.

9. The fuel injector as recited in one of claims 3, 4, 6, 7 or 8, wherein the top (14) is facing the valve needle (7) of the fuel injector (1).
